(19) United States
(12) Patent Application Publication
(10) Pub. No.: US 2009/0092341 A1
(43) Pub. Date: Apr. 9, 2009

(54) SEALED BIODEGRADABLE TRASH BAG

(76) Inventor: Trent H. Mallory, (US)

Correspondence Address: AKIN GUMP STRAUSS HAUER & FELD, LLP, P O BOX 688, DALLAS, TX, 75313-0688, US

(21) Appl. No.: 11/869,419

(22) Filed: Oct. 9, 2007

(51) Int. Cl. B65D 30/02; B28B 11/00; B65D 30/00

(52) U.S. Cl. 383/1; 264/241; 383/37

(57) ABSTRACT

The present invention is generally directed toward a product, such as a trash bag or other flexible, walled container, that is manufactured using a tubular film of biodegradable material. The product is a biodegradable bag being manufactured by folding at least one time along a longitudinal line, and sealing together the plurality of layers of the folded tubular film of biodegradable material. The tubular film is also provided with a first and second transverse cut. The first transverse cut is adjacent to the seal on a first side of the seal to define the bottom of the bag. The second transverse cut is spaced away from the seal on a second side of the seal to define the upper opening of the bag.

### REFERENCE TO RELATED APPLICATIONS

Not Applicable.

### BACKGROUND OF THE INVENTION

The present invention relates to a specific type and method of construction for sealing and securing trash bags manufactured from biodegradable material.

Trash bags may be utilized in a wide variety of applications. Generally, the trash bags may be constructed from a thin, flexible film, which is almost always a polymeric, or plastic, tube. The tubular polymeric film has a carefully chosen diameter such that the circumference of the polymeric film can serve as the side walls for a plastic trash bag. These bags may be available in a variety of sizes and configurations for different types of applications. One of the more common types of polymeric material used in the construction of plastic trash bags is polyethylene.

As technology has evolved, the polyethylene used for trash bags has improved significantly over the years in terms of strength and other physical properties. Therefore, the polyethylene bags manufactured today can utilize extremely thin polymeric film while maintaining a high-level of material strength. However, the strength of the seals are equally important, as seals are commonly utilized to form the bottom of the plastic bag.

Polymeric trash bags are generally manufactured utilizing a blown-film process using techniques well-known in the art. As the blown-film polymeric tube cools, the tube is flattened and the manufacturing process introduces a series of folds, seals, cuts, and perforations, which depend on the desired size and configuration of the end product. General focus has been on maximizing the capacity of the bag, so most manufacturing processes are geared toward making the largest possible trash bag for a given amount of polymeric material.

Most commercially-available bottom-sealed plastic trash bags are scaled by introducing a single seal extending across the polymeric film using a combination of heat and pressure. The single seal fuses the top and bottom layer of the flattened polyethylene tubular film. Polyethylene is generally resilient to the effect of the heat and pressure, so the resulting seam, when cooled, is relatively strong. Overall, the heat and pressure do not significantly degrade the structural integrity of the polyethylene bag as a whole. Therefore, newer, improved techniques to enhance the strength of the seals have not been needed. In fact, the alternative sealing arrangements and techniques are generally directed toward providing alternative configurations of bags, such as a gusseted bag, for convenience reasons, not due to structural necessity. However, new biodegradable materials have created a need for alternative approaches to sealing bags to ensure adequate structural integrity of the final product.

New biodegradable materials can resemble plastic, or polymeric, materials such as polyethylene in many respects. The material is relatively pliable, can be formed into thin sheets, is water resistant, and feels similar to polyethylene. These biodegradable materials are growing in importance in the larger society along with the demand for environmentally-friendly materials. These materials have a tendency to break-down quickly when exposed to environmental conditions over time, which can be accelerated when exposed to higher temperature levels. However, the primary feature of the biodegradable material, its propensity to break-down when exposed to environmental conditions such as heat, can also be one of its biggest disadvantages.

As previously discussed, the manufacture of trash bags using polymeric materials, especially polymeric tubes, requires the application of pressure and heat to impart seals into the material to form the plastic bags. However, when biodegradable materials are utilized as the substrate for a product, such as a trash bag, the heat and pressure can have a negative impact on the structural integrity of the biodegradable material. While two or more sheets of biodegradable material will fuse together when exposed to sufficient heat and pressure, the biodegradable material in close proximity to the heat and pressure is compromised structurally, reducing the strength of the material, especially the seal. Therefore, when utilizing biodegradable material in any weight-bearing container, especially trash bags, considerations regarding the structural integrity of the material is critical.

Therefore, it would be desirable to provide new alternative means for sealing a biodegradable trash bag. Accordingly, the present invention provides unique techniques and methods for addressing the specific challenges presented by biodegradable materials.

### SUMMARY OF THE INVENTION

The following description and the appended drawings set forth in detail certain illustrative embodiments of the present invention. These embodiments are only exemplars of but a few of the various ways in which the principles of the invention may be employed. There has thus been outlined, rather broadly, features of the invention in order that the detailed description thereof that follows may be better understood, and in order that the present contribution to the art may be better appreciated.

The present invention is generally directed toward a product, such as a trash bag or other flexible, walled container, that is manufactured using a tubular film of biodegradable material. The product is a biodegradable bag being manufactured by folding at least one time along a longitudinal line, and sealing together the plurality of layers of the folded tubular film of biodegradable material. The tubular film is also provided with a first and second transverse cut. The first transverse cut is adjacent to the seal on a first side of the seal to define the bottom of the bag. The second transverse cut is spaced away from the seal on a second side of the seal to define the upper opening of the bag.

### DESCRIPTION OF THE SEVERAL VIEWS OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

FIG. 1 depicts a cut-away view of a flattened, tubular film of biodegradable material.

FIG. 2 depicts a cut-away view of a flattened tubular film of biodegradable material, folded a single time along the longitudinal axis of the tubular film.

FIG. 3 depicts a cut-away view of a flattened tubular film of biodegradable material, folded first along the longitudinal axis of the tubular film and then folded a second time along the central axis of the once-folded tubular film.

FIG. 4A provides a perspective view of the twice-folded tubular film of biodegradable material with a seal and a perforation provided in the twice-folded tubular film.

FIG. 4B provides an overhead view of the twice-folded tubular film of biodegradable material with a seal and a perforation introduced into the twice-folded tubular film.

FIG. 5 depicts an overhead view of an opened trash bag of biodegradable material as contemplated by the present invention.

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

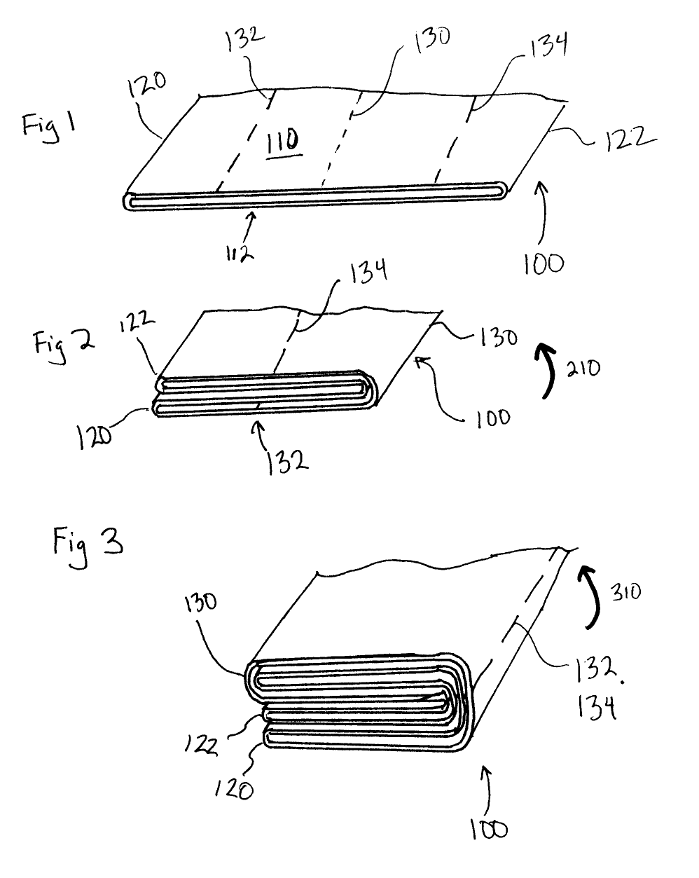

Referring to FIG. 1, a flattened tubular film 100 of biodegradable material is depicted in a cut-away view. The material is shown in a slightly exaggerated fashion to emphasize the different layers of the tubular film 100 when folded multiple times. In practice, the top half 110 of the tubular film 100 of biodegradable material is adjacent and flush with the bottom half 112 of the tubular film 100. The tubular film 100, when flattened, defines a first folded edge 120 and a second folded edge 122. A center-line 130 is represented by a line of short dashes for reference. Similarly, quarter-lines 132, 134 are represented by a line of longer dashes.

The center-line 130 is located at a location approximately equidistant from the first folded edge 120 and the second folded edge 122. Quarter-line 132 is located at a position approximately equidistant from the first folded edge 120 and the center-line 130. Similarly, quarter-line 134 is located at a position approximately equidistant from the second folded edge 122 and the center-line 130. The center-line 130 and quarter-lines 132, 134 will be the lines used when successively folding the tubular film 100 of biodegradable material.

Referring to FIG. 2, the tubular film 100 of FIG. 1 is shown after a first longitudinal fold. In FIG. 2, the tubular film 100 of FIG. 1 has been folded over the center-line 130, such as depicted by arrow 210. After this first fold, it is clearly apparent that the two quarter-lines 132, 134 are now immediately adjacent to one another.

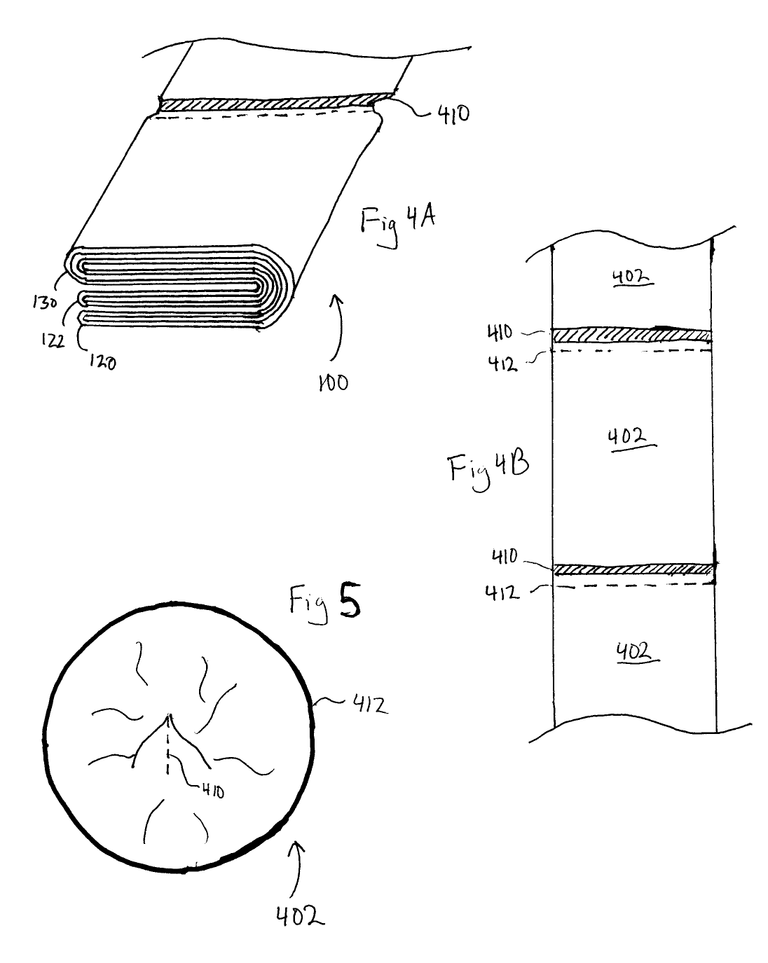

Referring now to FIG. 3, the tubular film 100 is again depicted, wherein the once-folded tubular film 100 of biodegradable material depicted in FIG. 2 is folded a second time along the quarter-lines 132, 134 as depicted by arrow 310. After the second fold, FIG. 3 illustrates that the original two-layer tubular film 100 shown in FIG. 1 is now twice-folded and comprises a total of eight layers of biodegradable material. In this configuration, the tubular film 100 may be sealed and cut as illustrated in the FIGS. 4A and 4B so as to provide the end product depicted in FIG. 5.

Although FIGS. 1, 2 and 3 depict a particular method of folding the tubular film 100, it is contemplated that the present invention may encompass other suitable methods of folding the tubular film. Generally speaking, the embodiment of FIGS. 1, 2 and 3 could be described as defining a double V-fold. However, other embodiments such as a W-fold configuration would be equally suitable for the present invention. Furthermore, although the present depicted embodiment comprises eight layers, other configurations such as a six-layer configuration having a Z- or S-shaped final configuration would be equally applicable to the present invention.

Referring now to FIGS. 4A and 4B, a twice-folded tubular film is depicted as in FIG. 3 except a seal 410 has been introduced to form the bottom edge of the final product, better illustrated in FIG. 5. Immediately adjacent to the seal 410 is a transverse cut or perforation 412 which will define the bottom of the trash bag. FIG. 4B depicts an overhead view of the twice-folded tubular film 100 of biodegradable material. A plurality of biodegradable trash bags 402 are formed, each trash bag 402 having an upper opening defined by the transverse cut 412 and a lower bottom defined by the seal 410. Alternatively, a series of perforations, rather than a cut 412 would provide a series of connected trash bags that can be rolled, and individually torn from the roll by the consumer.

The final product is better seen with reference to FIG. 5. In FIG. 5, a preferred embodiment of the biodegradable trash bag 402 according to the present invention is depicted. The upper opening, defined by the transverse cut 412, is shown from the perspective of an overhead view. The trash bag 402 is generally opened along the upper opening. The bottom, defined by the seal 410 and not directly visible from above, is shown by the dashed lines.

What is claimed is:

1. A biodegradable bag, comprising:
a film of biodegradable material,
the film folded a first time over a first longitudinal line to provide a folded film,
the folded film having a seal extending transversely across the width of the folded film, the seal comprising a plurality of layers of the folded film bonded together,
the folded film having a transverse cut adjacent to the seal on a first side of the seal to define the bottom of the biodegradable bag, and the folded film having a transverse cut spaced away from the seal on a second side of the seal to define the upper opening of the biodegradable bag.

2. The biodegradable bag of claim 1, wherein the film is a tubular film of biodegradable material.

3. The biodegradable bag of claim 1, wherein the first longitudinal line is centrally located on the film.

4. The biodegradable bag of claim 1, further comprising:
the folded film folded a second time over a second longitudinal line.

5. The biodegradable bag of claim 4, wherein the folded film is provided in a double-V-fold configuration.

6. The biodegradable bag of claim 4, wherein the folded film is provided in a W-fold configuration.

7. The biodegradable bag of claim 1, wherein the seal comprising a plurality of layers of the folded film bonded together by heat.

8. The biodegradable bag of claim 1, wherein the seal comprising a plurality of layers of the folded film bonded together by pressure.

9. The biodegradable bag of claim 1, wherein the seal comprising a plurality of layers of the folded film bonded together by a combination of heat and pressure.

10. A method for manufacturing a biodegradable bag comprising the steps of:
providing a tubular film of biodegradable material,
folding the tubular film of biodegradable material a first time along a longitudinal axis,
bonding a plurality of layers of the folded tubular film along a transverse axis of the tubular film to form the secured bottom of the biodegradable bag, and
cutting the folded tubular film along a transverse axis of the tubular film to form the upper opening of the biodegradable bag.

11. The method for manufacturing a biodegradable bag of claim 10 further comprising the step of:
folding the tubular film of biodegradable material a second time along a longitudinal axis before the step of bonding the folded a plurality of layers of tubular film.

12. The method for manufacturing a biodegradable bag of claim 10, wherein the step of bonding a plurality of layers of the tubular film further comprises:
applying heat to the plurality of layers to fuse the plurality of layers together.

13. The method of claim 11, wherein the steps of folding the tubular film of biodegradable material a first time and a second time provide an eight-layer double V-fold tubular film.

14. A system of connected biodegradable bags, comprising:
a tubular film of biodegradable material,
the tubular film folded at least one time over a longitudinal axis of the tubular film to comprise a folded tubular film,
the folded tubular film provided with a plurality of transverse seals along the length of the tubular film,
the folded tubular film provided with a plurality of transverse cuts along the length of the tubular film, each of the plurality of transverse cuts being in close proximity to one of the plurality of transverse seals, wherein the transverse cut defines the upper opening and bottom of adjacent biodegradable bags.

15. The system of claim 14, wherein each of the plurality of transverse cuts is a line of perforations extending transversely across the folded tubular film.
